(19) United States
(12) Patent Application Publication
(10) Pub. No.: US 2007/0174188 A1
(43) Pub. Date: Jul. 26, 2007

(54) ELECTRONIC MARKETPLACE THAT FACILITATES TRANSACTIONS BETWEEN CONSOLIDATED BUYERS AND/OR SELLERS

(76) Inventor: Robert D. Fish, Tustin, CA (US)

Correspondence Address: Rutan & Tucker, LLP.;Hani Z. Sayed, 611 ANTON BLVD, SUITE 1400, COSTA MESA, CA, 92626, US

(21) Appl. No.: 11/625,926

(22) Filed: Jan. 23, 2007

Related U.S. Application Data
(60) Provisional application No. 60/762,449, filed on Jan. 25, 2006.

(51) Int. Cl. G06Q 40/00

(52) U.S. Cl. 705/39

(57) ABSTRACT

Systems, databases, methods, and implementations provide for electronic management of negotiations for a proposed transaction, where at least one of the first and second sides of the transaction include multiple subscribing parties. Contemplated transactions preferably, but do not necessarily rise to the level of a legally biding commitment, and include all manner of transactions for goods and services. The basic terms of a proposed transaction will usually, but not necessarily, apply to all parties. Preferred embodiments are also parameter driven, and self-evolving, and handle basic transaction terms such as action, item description, quantity, maximum price, commitment windows, and close date, as well as additional transaction terms that may or may not have been adopted by previous users. Transactions can be single for single or multiple lots.

This application claims priority to U.S. provisional application No. 60/762449, filed Jan. 25, 2006.

### FIELD OF THE INVENTION

The field of the invention is databases for storing and retrieving information.

### BACKGROUND OF THE INVENTION

Several of my previous inventions were directed to systems and methods for storing and retrieving data for different types of items. In U.S. Pat. Nos. 6,035,294, 6,195,652, and 6,243,699, the focus was on a database that evolved by virtue of: (a) users being able to add their own parameters for a given type of item; and (b) the list of available parameters being shown to subsequent users in a list that was sorted by frequency of use. Frequently used parameters would eventually float to the top of the list, while infrequently used parameters would sink to the bottom of the list. At the time it was also contemplated that users could add their own values to a values listing, which could similarly be sorted by frequency of use, so that commonly used values would appear at the top of the list while infrequently used values would sink to the bottom. The three patents listed above, and all other patents and applications discussed herein are incorporated by reference in their entirety. Where a definition or use of a term in a reference, which is incorporated by reference herein is inconsistent or contrary to the definition of that term provided herein, the definition of that term provided herein applies and the definition of that term in the reference does not apply.

In general, the focus of those patents was on storing and retrieving data. The idea was that sellers would list information regarding the items they are offering, and that counterpart buyers would see the information and contact the buyers directly. The reverse was also contemplated, where buyers could list items they wanted to acquire, and that counterpart sellers could then contact the buyers to complete a transaction. The terms “buyers” and “sellers” were broadly construed to include not only straight sell/purchase arrangements where both possession and title are transferred, but all other types of transactions including leases, rentals, and so forth.

The '652 patent did address use of specialized parameters to store auction information. In particular, the '652 patent suggested use of “last price bid”, “last bid date”, and “closing date/time” parameters. The example given was that a user looking for a particular book would be presented with a single table showing fixed price offerings from volume retailers such as e-bay™ and Barnes & Noble™, as well as offerings of smaller companies, individuals selling new and used copies of the book, offerings by auction, and so on. Thus, although it was contemplated that one could store auction information on the system, it was not contemplated that the system could actually conduct auctions or other transactions.

Whether one used the self-evolving database concept to directly or indirectly facilitate a transaction, the three patents mentioned above always contemplated that transactions would occur on a lot-by-lot basis (whether the lot consisted of a single item or multiple items) between an individual seller and an individual buyers. Thus, a person having an automobile to sell would list characteristics of the automobile on the system, and hopefully sell that one car to an individual buyer.

It is now appreciated that there is a need to facilitate transactions that include consolidations on one or both sides of the transaction. Examples include situations where a given buyer cooperates with other buyers to increase his purchasing power, and where a seller cooperates with other sellers to accommodate an order that would be too large for any of them to handle individually. It is also appreciated that a need exists for such systems and methods to handle negotiation and finalization of the transaction, as opposed to merely storing and retrieving data.

It is already known in some circumstances to consolidate resources to satisfy one side of a proposed transaction. For example, it is common for a real estate syndicator to secure an option to purchase a building or other asset, and then try to raise money from third party investors to actually purchase the asset. Such syndications often involve securing subscription agreements in advance from potential investors, each of which would own partial rights to the asset, either directly or perhaps through stock in a company that would own the asset. If enough people sign up, then the deal goes through. If the syndicator fails to secure enough subscriptions, the deal may be postponed or scuttled. Similar subscription agreements are also commonly used in funding start-up companies, and spin-offs of existing companies. Investment groups have long consolidated very small investments of individuals, which the groups then use to purchase stock. US 2001/0032157 to Dunnenberg (publ. October 2001), teaches systems and methods that implement that process using a networked system to consolidate investments.

As another example, GMT Games™ operates a program called Project 500™ through a web site at http://www.gmtgames.com/p500/gmtp50.asp. The idea is that GMT Games will only begin producing new board games when 500 people have committed in advance to purchasing the game. The early committers obtain a special founder's price, while latecomers are charged a higher price.

In yet another example, it is common for a real estate developer to purchase land (or an option for the land), but then only begin to build upon receiving some minimum number of commitments from home owners or tenants.

In each of these instances the transaction has a single entity (the syndicator, consolidator, developer, or builder) on one side of the transaction, and multiple entities on the other side. As used herein, the two sides of a transaction are sometimes referred to as a “first side” and a “opposing second side”. The term “opposing” in that context merely means that the second side is opposite the first, as in buyer-seller, lessor-lessee, lender-borrower, landlord-renter. The sides are not necessarily opposing in the sense that they are antagonistic to each other.

In any event, what the current inventor has now appreciated is that the single entity side is always the one that (at least initially) sets the deal terms. Indeed, that is how the single entity tries to ensure control and/or profit for himself. He (or it in the case of companies) is the deal-maker, and sets up the terms between himself and the entities being consolidated. This is all well and good for the dealmaker, but it often leaves the counterparty investors, purchasers, tenants, licensees, etc with little market power, and possibly a raw deal.

It is known in very complex dealings for consolidation to take place on both sides of a transaction. For example, a group of industry leaders might pool their resources to develop and manufacture a new type of computer chip, and then market the chips to both themselves and others. In such instances the deal may well be contingent upon sufficient purchase commitments for the final product, so that nothing happens unless there is sufficient commitments on both sides of the transaction.

Unfortunately, that last class of many-to-many transactions, and indeed even a large number of one-to-many transactions, are very often dependent upon personal or pre-existing business relationships among the parties. And they are often so complicated, and involve such large sums of money, that they can only be implemented using a cadre of lawyers on all sides. Once again this leaves smaller counterparty investors, purchasers, tenants, licensees, etc with little market power. What is needed is an electronic marketplace in which substantially any parties can consolidate their resources to buy, sell, lease, rent, design, manufacture, and forth.

The various existing web-based or other electronic transaction sites fail to address consolidation on both sides, and even on a single side of a transaction. For example, EBay™ has long allowed substantially anybody to bid on purchasing substantially anything in a forward auction, and in 2005 began allowing sellers to compete in reverse auctions. But in both cases there is a complete absence of any electronic facility by which individuals or others can consolidate their resources to bid at the auctions. Hedgehog™ facilitates both forward and reverse auctions on a much more sophisticated level, often involving large corporations and governments, and contracts involving many millions of dollars. But even in that system there is no electronic facility by which individuals or others can consolidate their resources to bid at the auctions. The closest that Hedgehog comes to consolidation is to split up a large quantity of product or services something into smaller lots, each of which is handled as a separate transaction, without consolidation. That strategy, however, is problematic because buyers or sellers bidding against multiple fungible lots can game the system such that the different lots can settle for vastly different prices. Moreover, Hedgehog's auctions are run exclusively by invitation, such that only pre-qualified bidders can take part.

The point is that there is no electronic marketplace through which an ordinary purchaser of an item can cooperate with others to get a price that would reflect their consolidated market power. The best they can do is try to arrange a consolidated deal through a broker. Even in that case, a purchaser of a product or service is reliant upon the purchasing power of the broker, and a significant portion of the savings will go to that broker. On the flip side, there is also no electronic marketplace through which multiple sellers can cooperate with other sellers to satisfy a single order. Thus, when the U.S. government puts out a contract for 500,000 prefab housing units, or for removal of millions of tons of garbage after a hurricane, there are only a handful of companies that can place bids. The settle price is much too high, partly because the bidders form an oligopoly, and smaller players are left out in the cold. Even if the government splits the requirement into multiple lots, the bidding on those lots will be gamed by the big players so that once again the smaller players are effectively excluded from the process. It would be much better if hundreds of smaller providers could each offer to provide what services they could, and consolidate their resources to satisfy a single lot (line item).

### SUMMARY OF THE INVENTION

The present invention contemplates systems, databases, methods, and implementations for an electronic system for managing negotiations for a proposed transaction, where at least one of the first and second sides of the transaction include multiple subscribing parties.

Preferred embodiments include a system that stores identification and participation information regarding the subscribing parties, and interfaces for setting basic terms of the proposed transaction and entering subscribing information. To accommodate consolidated transactions, a suitable interface allows a party to enter its participation in a proposed transaction at less than 100%. All suitable data structures are contemplated, including localized and more preferably, distributed data structures, single or multiple tables, and single or multiple subsystems under control of single or multiple entities. Contemplated transactions preferably, but do not necessarily rise to the level of a legally biding commitment (i.e., and offer that can be accepted, or an acceptance of an offer), and include all manner of transactions. Exemplary transactions include commercial, industrial, governmental, and personal agreements, for sales, purchases, leases, rentals, etc., and even cooperative working agreements to write books or produce other original materials. The basic terms will usually, but not necessarily, apply to all parties.

Preferred embodiments are also parameter driven, and self-evolving. For example, an interface advantageously allows a maker to add a new parameter to the parameters list, and then present a subsequent maker with the parameter list updated to include the new parameter.

Similarly, an interface can advantageously allow a maker to set at least some of the basic terms at least in part by selecting values from a values list, to add a new values to the values list, and then present a subsequent maker with the values list updated to include the new value.

The system preferably handles basic transaction terms such as action, item description, quantity, maximum price, commitment windows, and close date, as well as additional transaction terms that may or may not have been adopted by previous users. Sets of transaction terms can advantageously be combined into transaction templates. Various useful functionalities can be included, preventing the subscribing parties from over-subscribing the transaction.

Viewed from another perspective, methods of facilitating a transaction involving transfer of funds are contemplated that include the steps of: (a) providing a first electronically operable facility through which a maker can set basic terms of the transaction; (b) providing a second electronically operable facility through which a second unrelated party can join with the maker in consolidating their resources to satisfy one side of the transaction; and (c) providing a third electronically operable facility through which a third unrelated party can subscribe as a counterparty to the transaction. Such methods can preferably handle additional unrelated parties, in forward and reverse auction formats, and can be open to the general public. Transactions can be for goods and/or services, which are not necessarily in existence at the time of the transaction. Transactions can be single for single or multiple lots.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1A is a mock-up of a sample search interface, showing a drop-down box to select parameters.

FIG. 1B is s the mock-up of FIG. 1A, showing a drop-down box to suggest addition of a new parameter, in this case roof racks for automobiles.

FIG. 1C is the mock-up of FIG. 1A, additionally showing a drop-down box to select values, in this case a make of an automobile.

FIG. 1D is a mock-up of the search interface of FIGS. 1A-1D, but in this case the user has selected the “Show All” option.

FIG. 1E is a mock-up of a search interface where the user is searching for records of Samsung™ i700™ PDAs for sale.

FIGS. 2A and 2B are mock-ups of sample search results display interfaces, showing summary results.

FIG. 2C is a mock-up of a sample search results display interface, showing detail of a full record.

FIG. 3 is a mock-up of a sample interface for adding new items.

FIG. 4 is a mock-up of a sample preferences interface, through which a user can store biographical and financial data on himself, and can select interface preferences such as number of records to display, adult content filter, and preferred units of measurement.

FIG. 5 is a schematic of parameters, values and items record layouts in a data repository.

FIGS. 6A-6F are mock-ups of sample interfaces for facilitating electronic consolidations.

FIG. 7 is a schematic of a preferred consolidation record layout.

### DETAILED DESCRIPTION

A. Interfaces

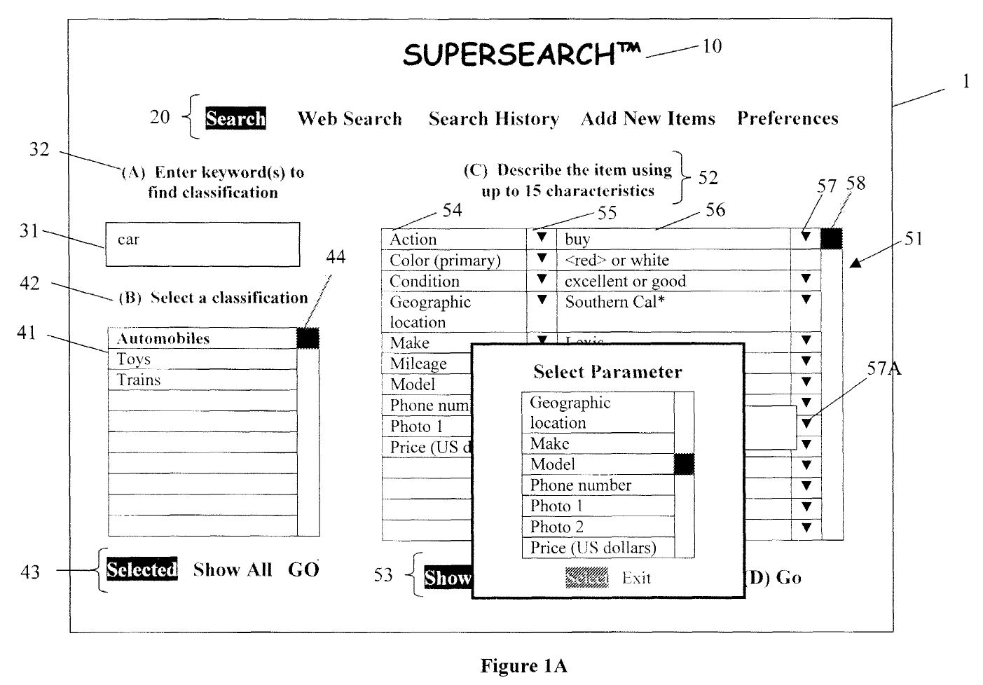

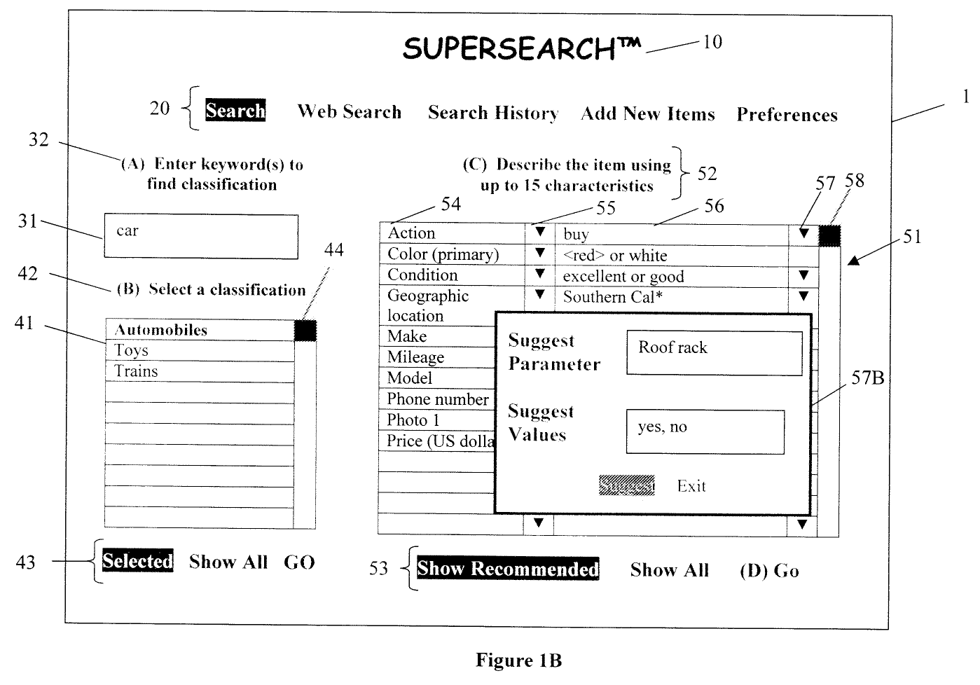

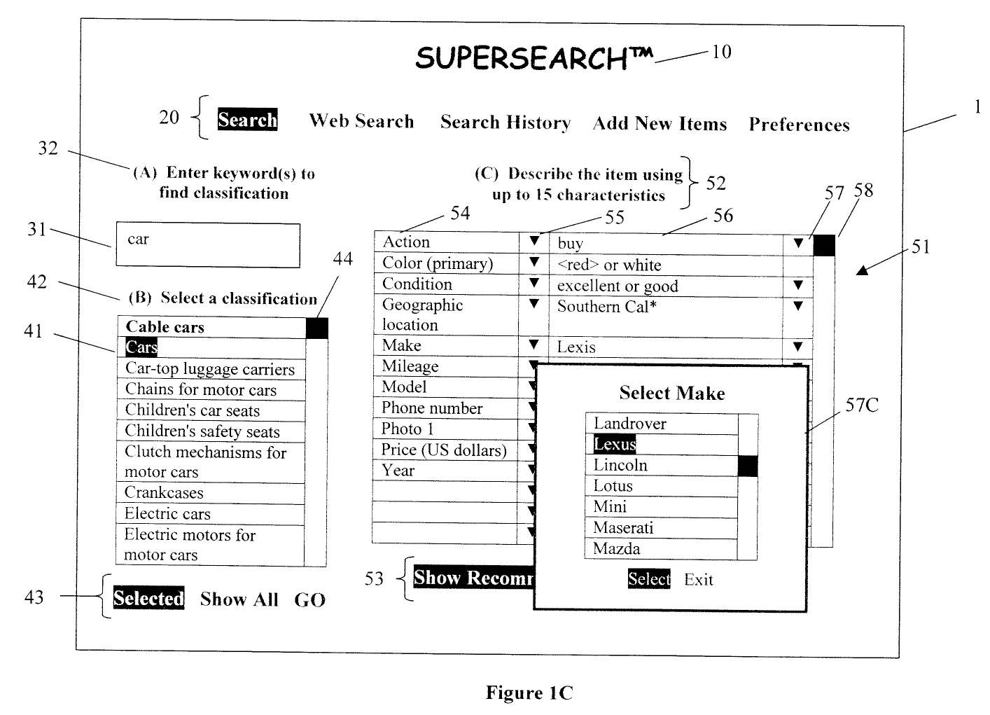

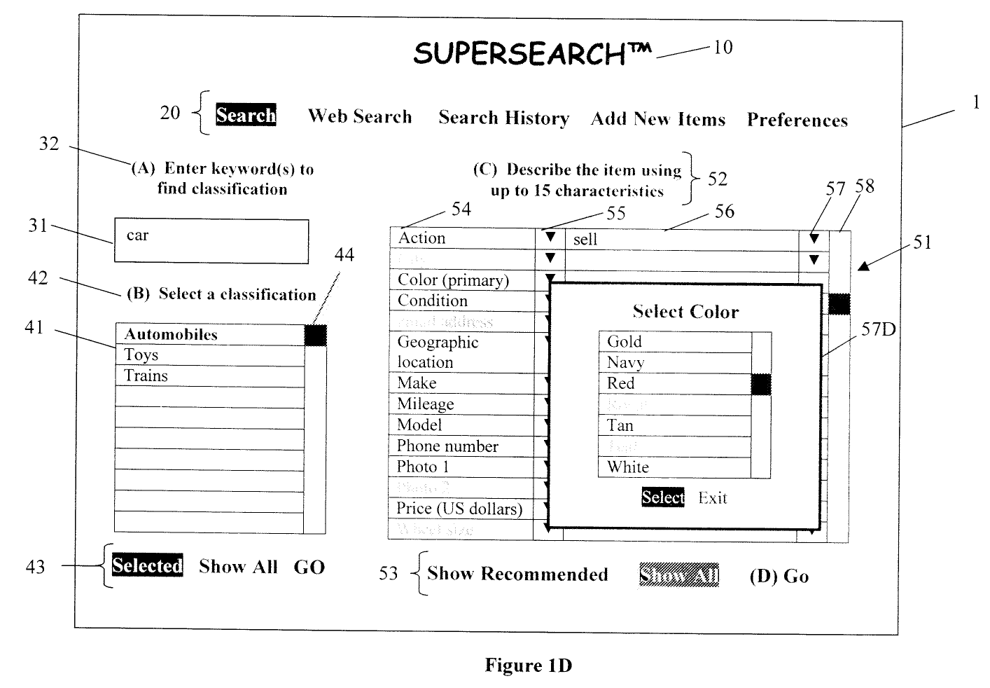

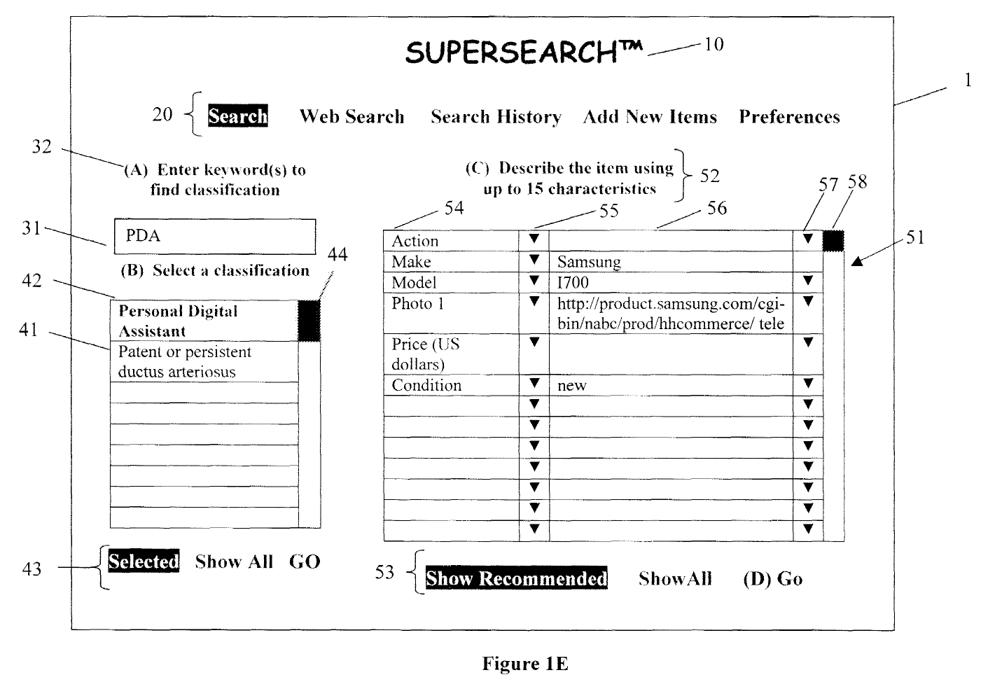

In FIGS. 1A-1D, a sample search interface 1 generally comprises a company identifier 10, a navigation line 20, box 31 and instructions 32 for entering keywords to identify an appropriate item classification, a classification results interface 41 and instructions 42, and an item description interface 51 with instructions 52.

As used herein, the terms “user”, “data provider”, “data searcher” and the like refer to natural persons within the general public, who may be entirely unsophisticated in their use of computers and databases, acting in their capacities as ordinary users of the system (whether for themselves or on behalf of a company, school, or other organization), and not to persons acting in their capacities as programmers, systems analysts or the like who modify the structure (as opposed to the content) of a database. The terms do not include computer programs, bots, and the like.

The mockups use the company identifier, Supersearch. That term is intended to be purely hypothetical, and any association with the same or similar name in the real world is purely accidental and unintentional.

Most of the items on the list will be self-explanatory. The general concept is that a user navigates if necessary by clicking on the search box in the navigation line 20. In step (A) the user then enters one or more keywords in box 31. In this particular example a user entered the term “car”. Depressing a tab, enter or other appropriate key on the user's keyboard causes the system to list possible item classifications. As used herein the term “causes” is used in a broad sense to include direct and indirect causation. Thus, a clicking action of the user only causes the system to respond in a given manner in the sense that there is software being executed by a computer that runs though sets of commands to achieve the result. Indeed, it should be appreciated that all of the computer steps discussed in this applicant are contemplated to be executed on one or more computer, and that all such software must at some time be resident on one or more computer readable media.

Having considered numerous different possible classification systems, and having even designing an extensive three level system, it is now contemplated that the best route is to utilize a classification that is the same as, or at least derived from, a trademark classification system. Such systems are already designed and battle-tested, and distinguish products and services the way they tend to be distinguished in the eyes of ordinary consumers. The two most preferred such classification systems are the U.S. and International classification systems used by the U.S. Trademark office. An example is shown in FIG. 1A. Here the user typed car, which on the USPTO webpage for Acceptable Identification of Goods and Services at http://tess2.uspto.gov/netahtml/tidm.html returns 95 listings, from “dope for model airplanes” in class 002 to ordinary “cars” in class 12, to “entertainment services” for participation in sporting events in 39.

In addition to physical goods and services (e.g, cars, boats, concert tickets, medical service providers), it should be understood that preferred systems can also include classifications for intellectual goods and services (e.g., newspaper, magazine and journal articles. definitions, and miscellaneous information such as home repair instructions), people, and so forth. As discussed below, there can also be classifications for users of the system (both those loading data and those merely searching), queries, and record sets. The last two categories can facilitate data mining based upon searches and record sets stored by others.

In step (B) the user can then double click on one of the selections to populate the parameters table 51. Since many users might balk at the term parameters, the interface uses the friendlier term, characteristics; the two being considered interchangeable in this application. Alternatively, the user can click on the Show All button on the classification selection line 43, which presents the user with an alphabetical listing of all classifications. Item 44 is a slider, which is of course only useful where there are more classifications in the list than can be displayed in the space available.

In step (C) the user changes one or more of the parameters 54 using the drop-down trigger 55 designated with the “▾” character, and then enters a filter value 56 if desired for one or more of the parameters, either by typing in data or by using the drop-down trigger 57, again designated with the “▾” character. FIG. 1A additionally shows a sample pop-up box 55B for selecting a parameter, in this case from the recommended parameters listing. FIG. 1B additionally shows a sample pop-up box 55B for suggesting a new parameter, in this case “Roof rack”. FIG. 1C additionally shows a sample drop-down box 57C for selecting a value, in this case automobile makes from the recommended values listing. Slider 58 allows the user to view additional rows (if any) of parameters/value pairs. Typically the user will be limited to selecting only a maximum number of parameters, such as 10, 15, 18, 20. The maximum number may remain constant, or perhaps more advantageously, may be changed by the system depending the item classification, since filtering for some types of items could require more parameters than others.

It is also contemplated that the available values from which the user makes his selection can be based not upon the recommended values for the corresponding parameters, but could be the universe of values for such parameters in a given record set. This alternative makes particularly good sense when doing trying to narrow down records from a web search (not shown), or when recalling a stored record set using search history (see not shown).

The item description selection line 53 allows a user to choose between listing only narrower recommended groups of parameters and values in the drop-down boxes, and listing broader groups of parameters and values. The system obviously could utilize separate selection buttons for parameters and values, but in this particular instance a single set of buttons controls both. Although optional, providing users with recommended lists is considered to be an important feature, and a significant advantage over the prior art. Among other things it still encourages users to add and search for commonly parameters and values, and thereby encourages but does not require strict conformance to a severely limited set. The lists can be sorted in any suitable manner, but more helpfully will likely be sorted alphabetically.

Although most of the appropriate parameters would presumably be available to the user in either the narrower or broader listing of parameters for this particular item classification, it is contemplated that users could suggest adding a parameter or even a value. Any suitable trigger could be used to pop up or otherwise access a suggestion window, but to keep matters simple it is preferred systems automatically pop up a suggestion window (see e.g. box 59) whenever a user enters text (not pure numbers) that doesn't match a previously known parameter or value.

It is contemplated that a user can only have one value for a given parameter, unless they are listed in the alternative. Thus, a user could select cars that are red or white, but not cars that are red and white, at least not while using a single parameter called color. To accommodate cars with two colors, the system can use parameters such as Color (primary) and Color (secondary). This manner of handling multiple values for a single type of parameter

It is still further contemplated that parameters can be related, so that choosing one parameter causes the system to automatically utilize the coupled parameter(s). Couple Parameters are most advantageously those parameters that relate to hierarchical information in the real world. Thus, if a user were to use the term “volume” as parameter with respect to automobiles, it would be wise to couple that parameter with another parameter such as “engine cylinders” or “interior”. Otherwise it is unclear whether the user is referring to engine displacement, interior space, trunk size, or size of gas tank.

Photos, video, and audio files can be searchable. Suitable filtering values will tend to vary from classification to classification, but as a general guide it can be said that such files can be searchable by matching with a link, another file, or description. For example, an audiovisual file could be searched for a particular sound clip, or it could be searched for text in a file name. Most of the time, however, it is contemplated that a user will include parameters relating to such files so that the links to the files will appear in the results matrix.

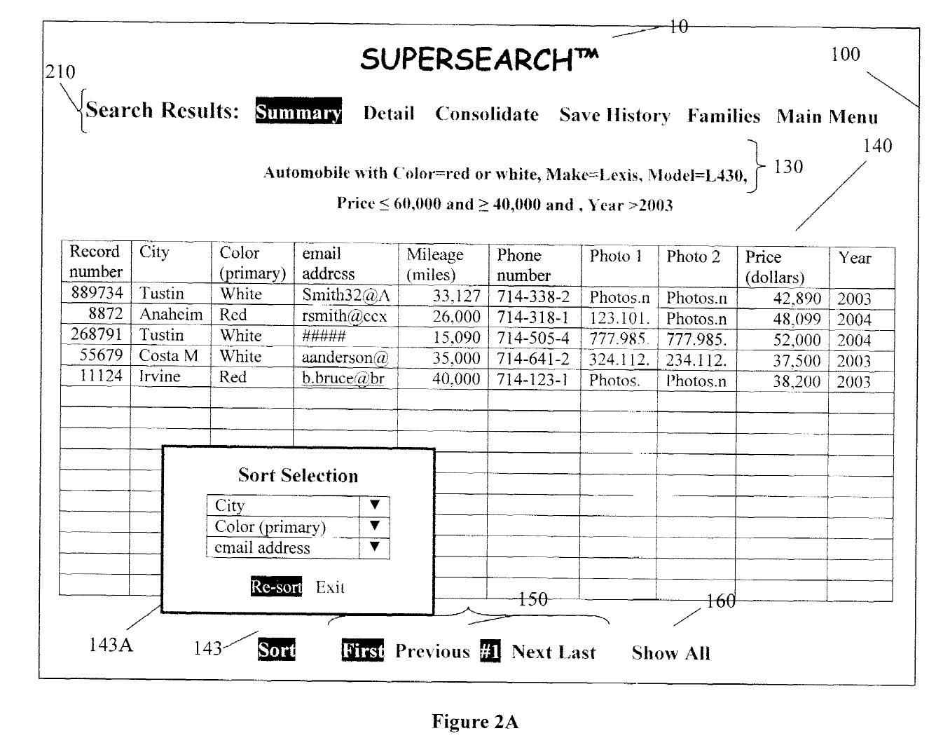

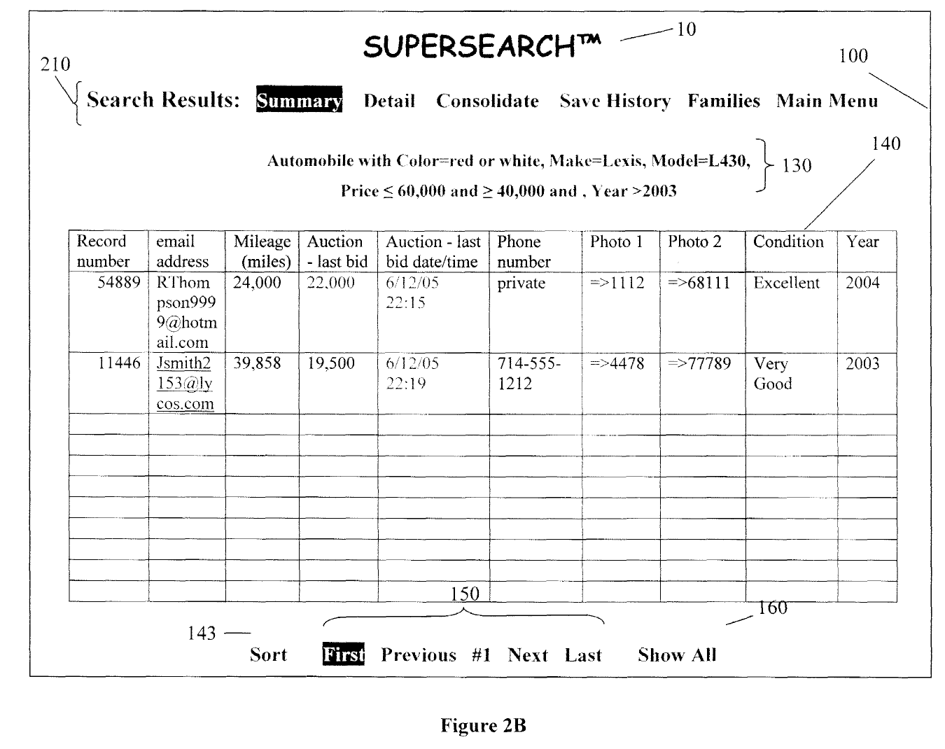

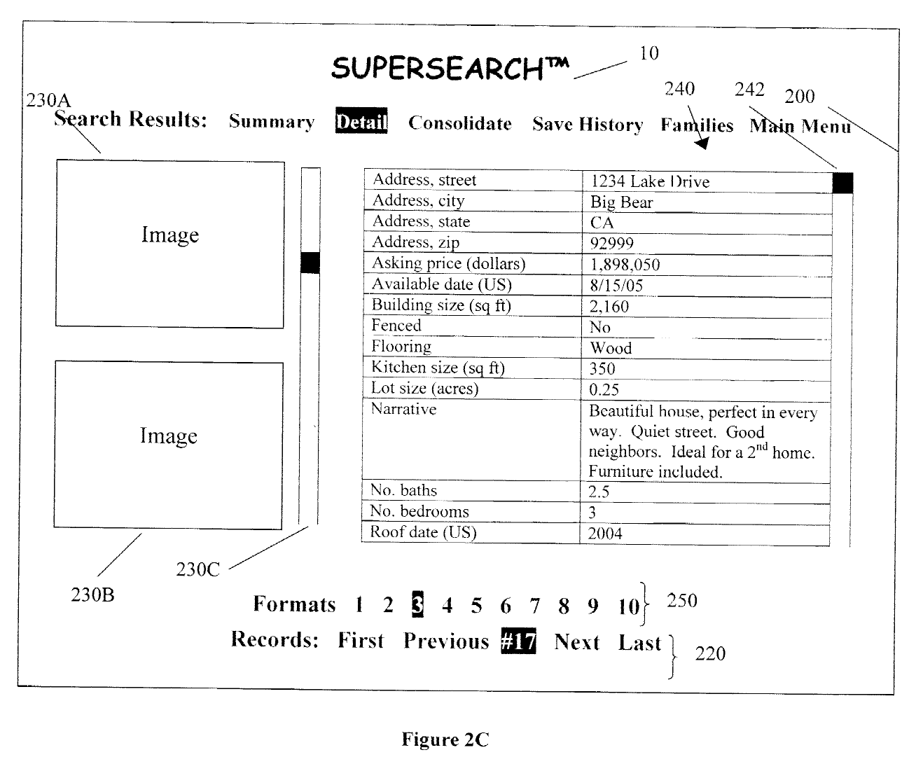

The careful reader will appreciate still further that some values can be left blank. Indeed, it may be that a searcher will leave most of the values blank because she doesn't want to filter on the corresponding parameters. Even so, selection of desired parameters is important, since at least in preferred embodiments the results matrix will include a column for each of the listed parameters (except perhaps, to save space, those parameters for which the user selected a single value). Thus, the column headings in FIG. 2A match with the parameters chosen in FIG. 1A, less those parameters for which the user selected a single value.

Of course, what constitutes the rows and columns of any table is merely a matter of perspective, and those skilled in the art will appreciate that the terms “row” and “column” are merely designators for axes in a matrix. Thus, with respect to the specification and the claims, any given description referring to rows and columns is to be interpreted both in the orientation described, and in an equivalent rotated or otherwise transposed orientation that provides substantially the same information.

Although it is not obvious from the figure, the values listed by drop-down box 59 are preferably linked to the parameter on the same line, and the selected item classification. Thus, both a narrower listing of recommended values and a broader listing of values would very likely vary significantly between an item classification of automobiles and an item classification of desktop printers. Both may include parameters of make, model, price, and condition, but automobiles would likely also include parameters for color, year, mileage and the like, while the printers might list speed, tray capacity, dots per inch, ink cartridge type, and so forth.

The recommended parameters and recommended values may be, but are not necessarily, related to frequency of prior usage. Indeed, there are advantages to recommending parameters and values that are not entirely based upon frequency of prior use, including especially the fact that the first users within a given item classification might otherwise get that classification off to a bad start by utilizing parameters and/or values that other users would find inappropriate, offensive, and so forth. It should also be appreciated that the term “recommended” parameters and values means that there is at least one parameter, or value as the case may be, that is not recommended. Thus, if a system stores values for ten parameters, and the user is shown all ten parameters without any distinguishing feature as to why one is recommended over another, then those parameters are not deemed to be recommended. The term “recommended” is also different from “required”. Thus, if a system stores ten parameters for a class of items, and requires data on three of those classes, then those three parameters are not considered to be “recommended” as the term is used herein. There may be another five parameters that are recommended, and in that case there would be three required parameters, five recommended parameters, and only two parameters that are not recommended.

Some of the values, such as “buy” in the first row, and Lexis in row seven, and L430 in row nine, are very likely available in the drop-down listings. Others, such as the price in the penultimate row, are likely to be typed directly by a user. It is contemplated that the system can try to complete the entry (autofill) as soon as the user begins typing. It is also contemplated that the system can check for spelling, and if a word appears to be mis-spelled, the system can inquire as to whether the user meant one or more standard spellings of words. Row three illustrates that a user could designate that a particular value can be searched using synonyms. In this instance <red> signifies that the system should also search for values such as maroon and rose. Row three also illustrates that preferred embodiments allow users to employ Boolean logic. Row six illustrates that preferred embodiments allow a user to employ wildcards. The price and year values in the final two rows demonstrate that preferred embodiments allow users to utilize open and/or closed ranges.

Units can be handled in any suitable manner. In preferred embodiments, each parameter to which units could reasonably apply is associates with a particular unit of measurement. However, the units used by a given user would usually be determined by a table in his Preferences, and the system would perform all conversions automatically. In this particular instance the user is assumed use U.S. dollars as his default currency, so the system shows price in U.S. dollars. If the user had chosen to use Euros, the parameter would preferably have shown “Price (Euros). Results from units conversion would preferably be rounded as shown to the user.

Finally, in step (D) the user clicks (or double clicks depending on preferences of the interface designer) on the GO button to cause the system to begin the search.

FIG. 1D is similar to FIGS. 1A-1C, except that the Show All button is selected. Here the system shows all available parameters, with the recommended parameters differentiated in some manner from the non-recommended parameters. In this particular case the system shows recommended parameters in normal black font, while the non-recommended parameters are grayed out. All differentiators are contemplated, including for example use of italics, bolding, different colors, and use of a (R) symbol. The drop-down box 57D shows all (meaning all or at least a superset of the recommended) values previously stored with respect to the color parameter. There would usually be similar drop-down boxes for values for the other parameters.

Although this particular embodiment shows buttons to select between Show Recommended and Show All, it should be appreciated that one could simply show all parameters and values all of the time. Even in that case, though, it would be desirable to default the parameters to recommended parameters, and in that manner eliminate unnecessary work on the part of users in deleting the undesired parameters from the search interface.

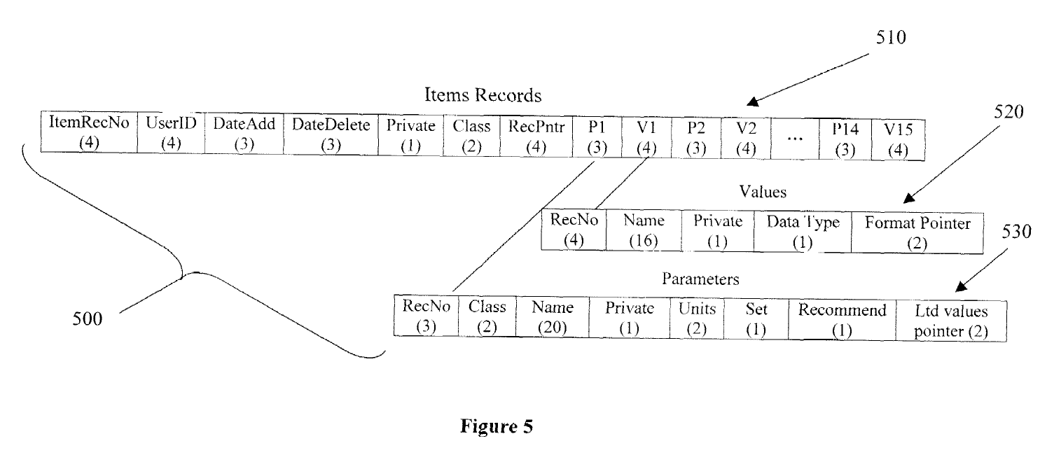

FIG. 1E is a mock-up of a search interface where the user is searching for records of Samsung™ i700™ PDAs. If the user had entered “sell” as the Action in column 54, then he would presumably be shown a table of records showing i700s for sale. If the user had entered “buy” as the Action in column 54, then he would presumably be shown a table of records where the listing entities want to purchase i700s. By leaving the cell blank, this results table would preferably show all new i700s, whether for sale or purchase. The user could then, for example, click on the Consolidate button in navigation line 20 to reach a listing of relevant proposed consolidations, such as that shown in FIGS. 5A-5E.

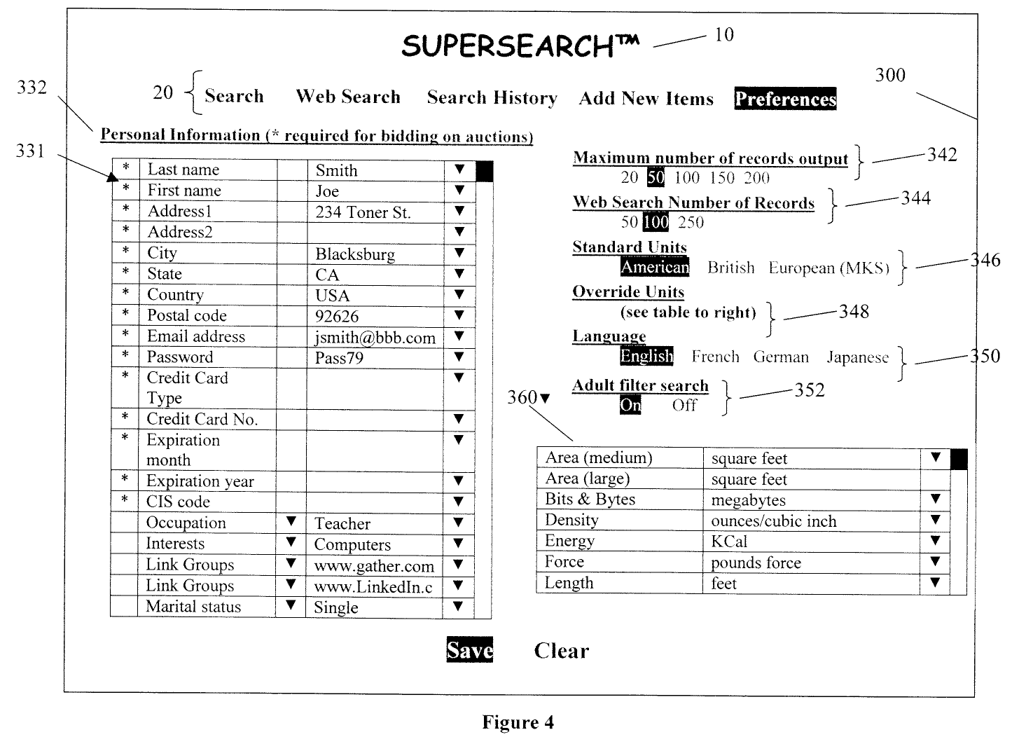

In FIG. 2A, an output interface 100 generally comprises a company identifier 10, a navigation line 120, a recap of filtering criteria 130, and a matrix 140 containing data. The matrix can be in Excel™ or other proprietary spreadsheet format, or more preferably is in a non-proprietary format. The matrix 140 can have any suitable number of data rows, but will likely have a maximum number of rows set in the Preferences interface (see FIG. 4).

In this particular case the data represents information responsive to the search of FIG. 1A. Readers will note that besides a record number, the table is limited to the columns identified in the search interface 51. This is not a hard and fast rule, but is advantageous because the user can often see in one place all the information he wants to see, but none of the information he didn't want to see. If the rows are too wide or too numerous, it is contemplated that the matrix can include horizontal and vertical sliders (not shown). It is certainly preferred that any links, such as those to the photos, will be live. It is also contemplated that clicking on the record number will trigger production of another interface (not shown) that shows all public parameters and values for the item, whether or not they were selected by the searcher.

Sorting can be straightforward as shown. When the user clicks on the Sort button in selection row 143, the system provides a pop-up window 143A through which the user can select primary (1°), secondary (2°), and tertiary sorts (3°). User navigation among the various sets is straightforward using the First, Previous, Next, and Last buttons in navigation section 150. The user can see where he is in among the various sets, and can also jump to a particular set using the # button. There may also be a Show All button 160 that would show all records rather than just the subset of 20, 50, 100 etc records selected in the Preferences, provided of course that there are not so many records that showing all of them would be unwieldy.

The reader will also appreciate that use of a drop-down, pop-up or other box is merely a design choice. Thus, for example, drop-down boxes can actually be implemented as a box that extends upwards rather than downward from the triggering icon, or can be placed left or right of the icon, or even elsewhere on the display. The reader should therefore understand that in the present application the choice of any of these boxes is merely presented as a matter of convenience, and that any of them could readily be substituted by any other of them.

FIG. 2B is similar to FIG. 2A except that some of the columns are directed to auctions. The links there can be live, and preferably point to individual pieces of data residing on a server that handles bids. As shown, auction parameters can advantageously include: Auction, last bid amount; Auction, last bid date/time; and Auction, last bid client number.

FIG. 2C shows a preferred format for presentation of a full record interface 200, along with resolved links. As with other preferred interfaces there is a navigation line 210 to other interfaces, but here there is also a selection line 220 to select another record in the items list, e.g. 140 of FIGS. 2A-2D. There are also images 230A, 230B, and a slider 230C to select among other images. Main data table 240 lists all parameters and value pairs for this item, and also includes a slider 242. If this interface were being used to reflect items just recently entered or modified by the data provider, it would include private parameter/value pairs, but if presented to another user the interface could hide entire private parameters and/or private values. It is contemplated that the format of the interface can advantageously be selected using format selector line 250. It is presently preferred that a limited set of available formats would be provided by the system designer, although and other formats may, for example, show more a single larger image, or more images without scrolling. As currently contemplated the format could be selected by the data provider on an item by item basis when this interface is presented to verify entered data, but could still be overridden by the searcher simply by clicking on a different format.

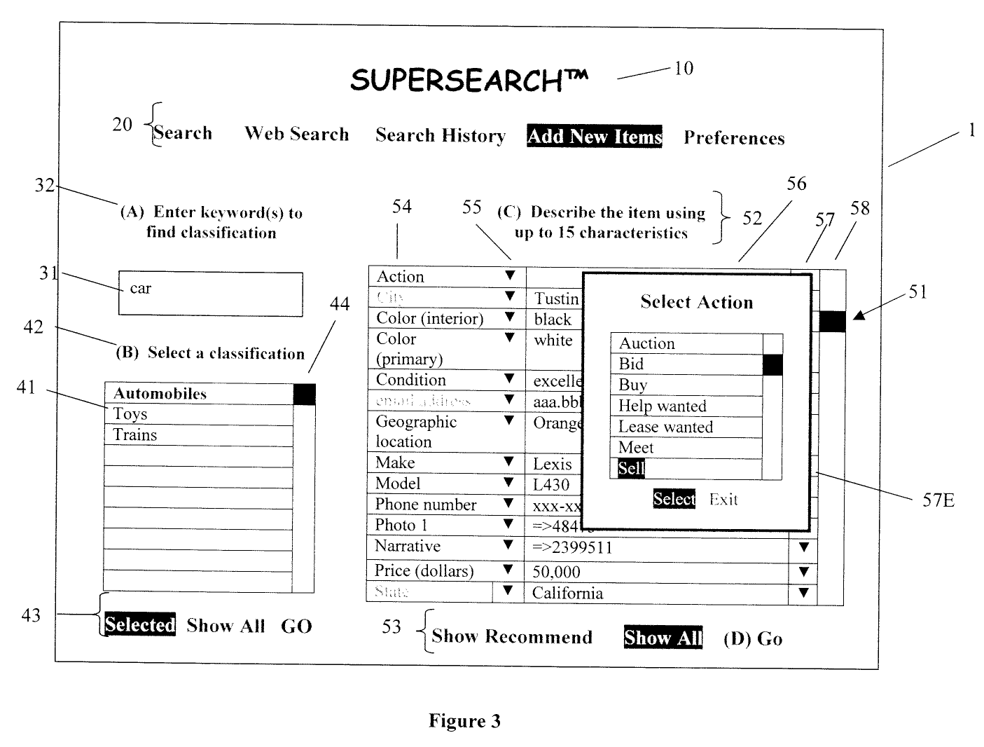

FIG. 3 shows substantially the same interface 10 of FIGS. 1A-1D, except that the navigation line 20 is selected to “Add New Items”, and the functionality is a bit different. In this case the user still goes through the same steps (A) through (D) as discussed previously, but here the user is acting as a data provider rather than a data searcher. Clicking on the GO button stores the item record, and takes the user to a verification interface, which can advantageously be a full record interface such as those of FIG. 4C. FIG. 3 shows a sample pop-up box 57F, which in this instance allows the user to either browse for a file or other data, or add long text that will be stored by the system.

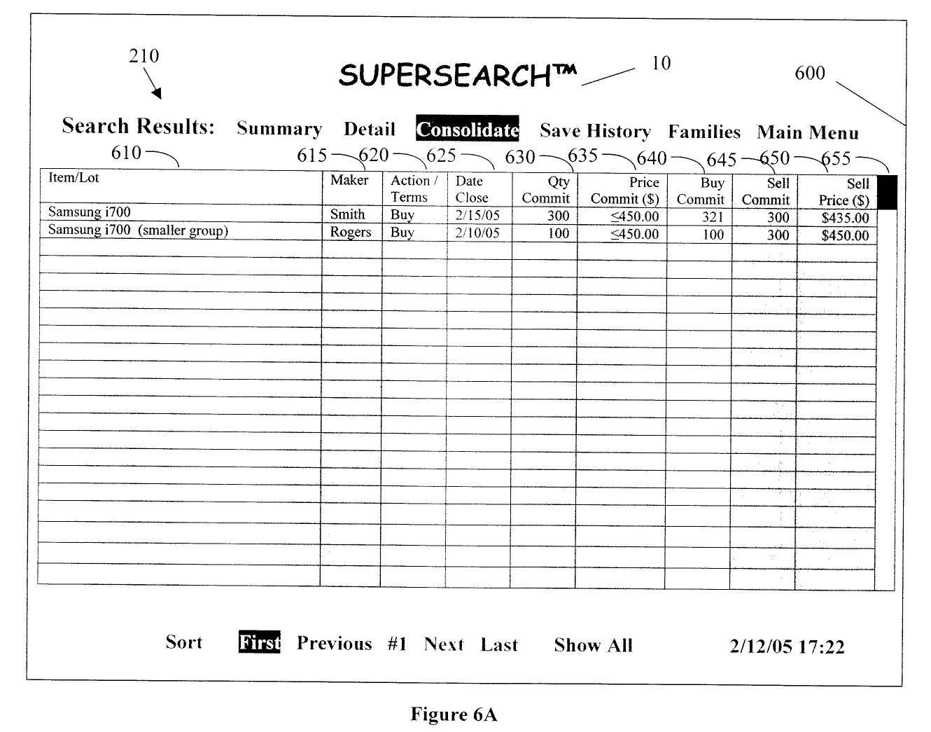

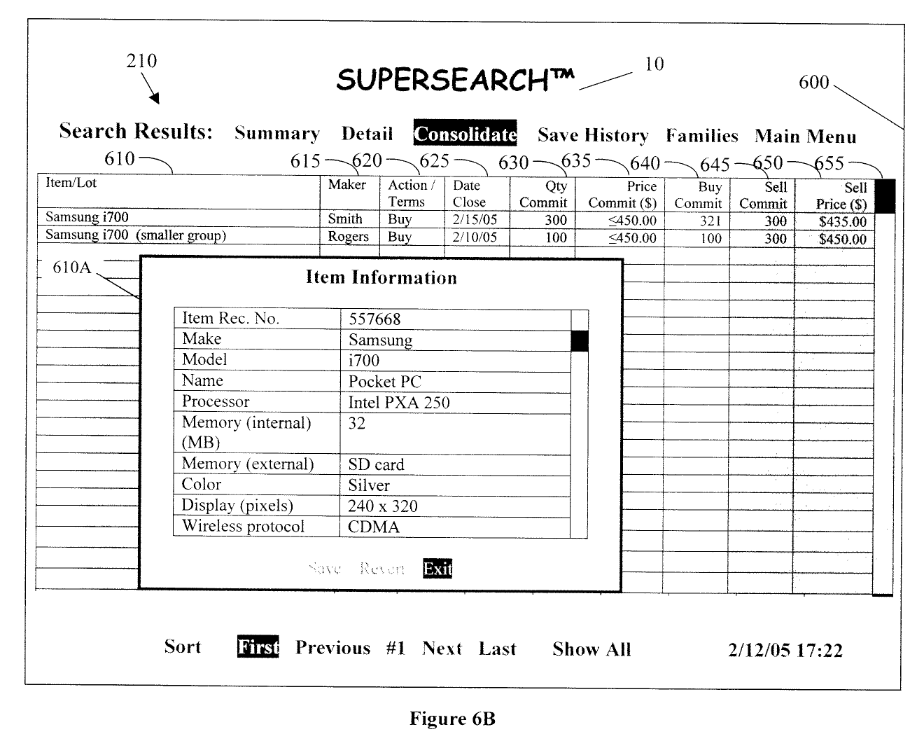

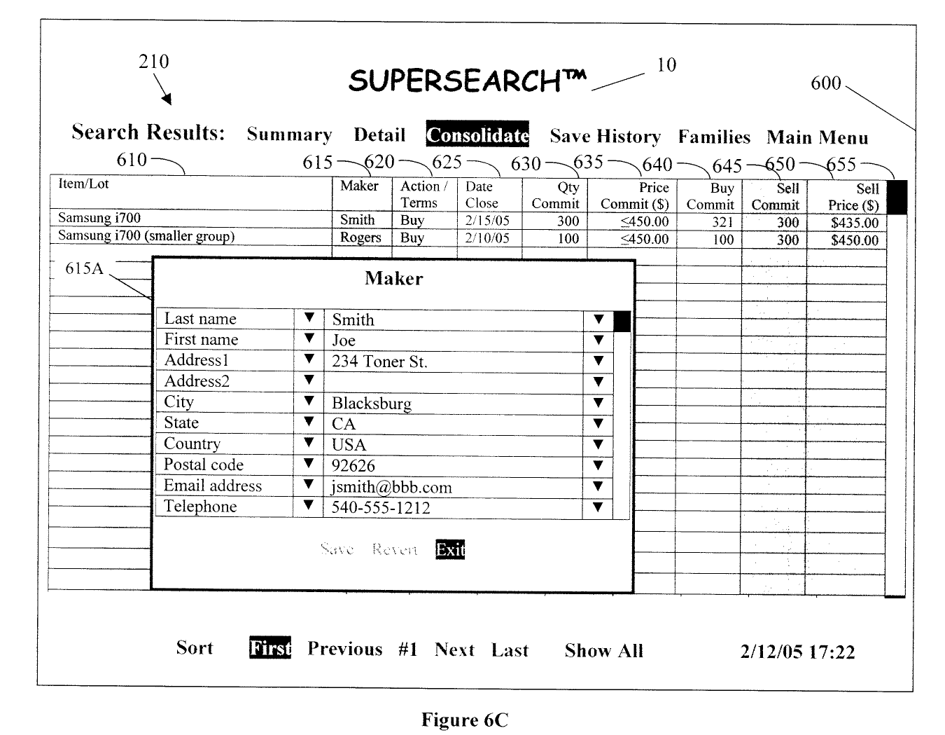

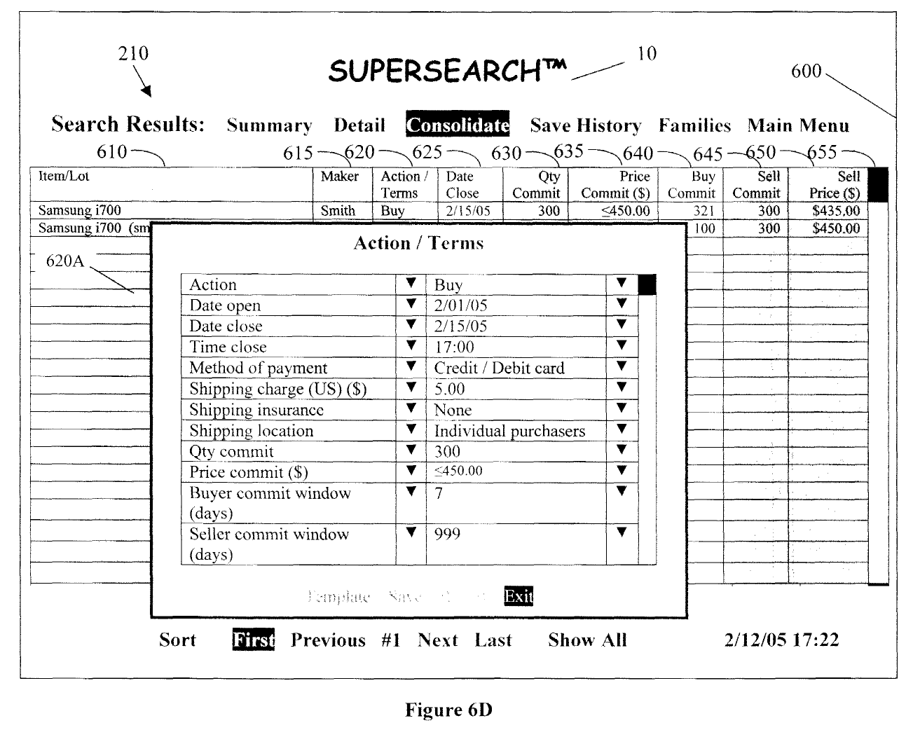

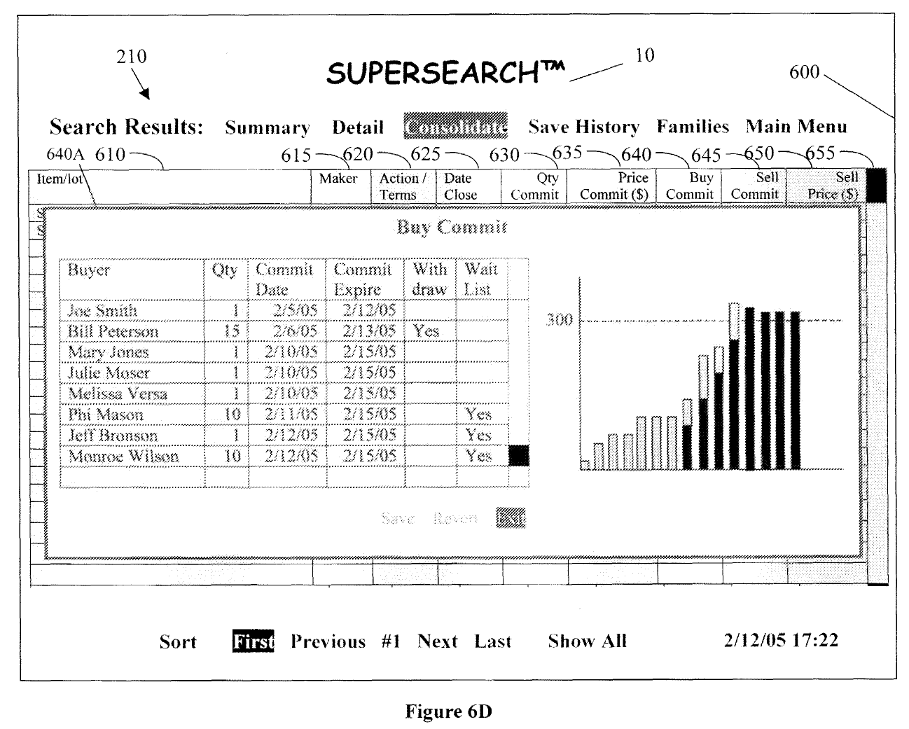

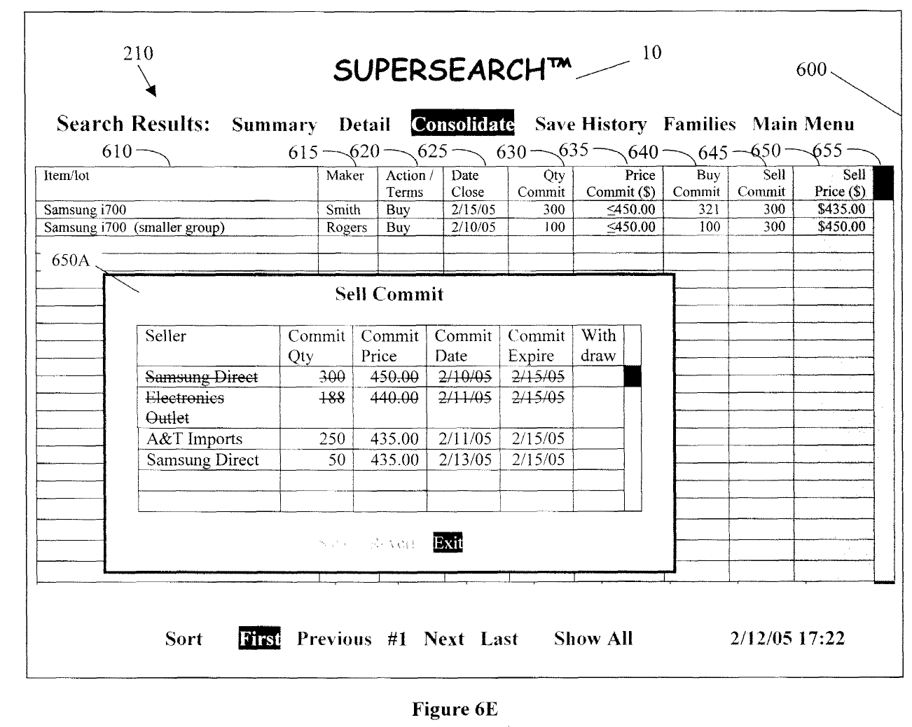

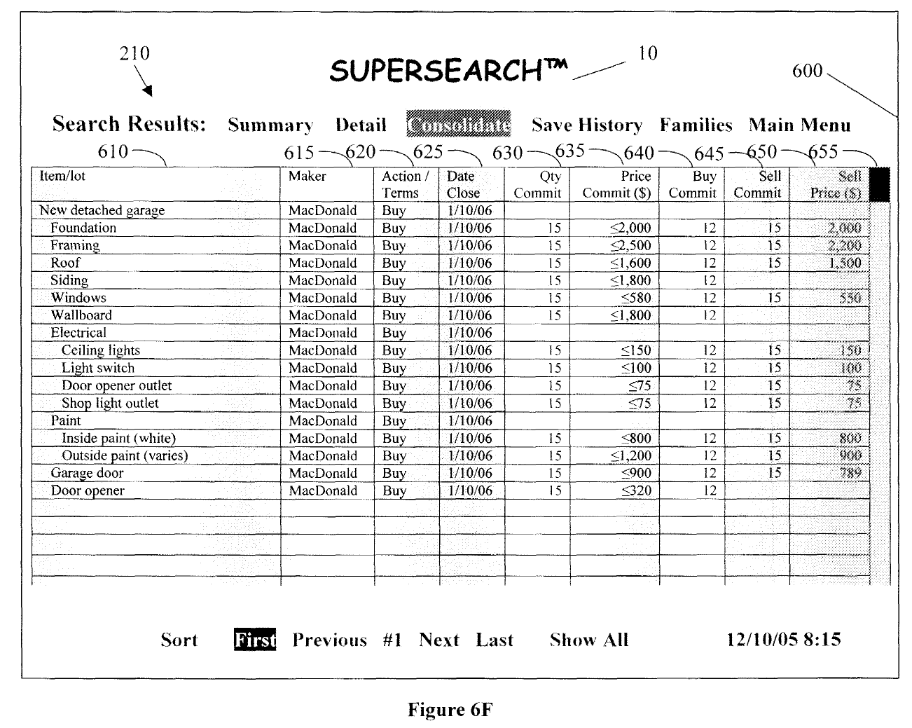

FIG. 4 is an interface for entering and maintaining user information and preferences. The interface 300 generally comprises the company identifier 10 and navigation line 20 discussed previously, and also includes a personal information table 331 and instructions 332, radio buttons for selecting groupings for maximum number of records output 342, web search number of records 344, standard units 346, override units 348, language 350, and adult filter 352, and a units table 360. Of course, the same or similar information could readily be gathered or selected in some other manner, and additional or other information than shown in FIG. 6 could be implemented.

In this particular embodiment the table shows both standard parameters of name, address, and so forth, and allows users to enter any other relevant information. Also shown are several optional parameters and values, in this particular example relating to occupation, interests, and marital status. Any of all of such information could advantageously be used in narrowing Web searches (not shown), or perhaps ranking search results.

In an especially preferred embodiment, the units table 360 is initially populated with values as a function of the selection in standard units 346, but allows a user to change his/her preferences on specific units. Thus, for example, a user may prefer to use American units for most measurements, but use MKS units for force. The interface also allows a user to select preferred units within a system. Thus, a real estate user may prefer to default to square feet for area, while a farmer may prefer to default to acres.

FIG. 5 shows a possible data structure 500 for storing item records. This structure utilizes a parameters table 510 that includes pointers to class, a literal of the parameter name, a designation of whether this parameter is kept private to data providers, a pointer to a units table, a group number that could be used to group parameters, a designation as to whether this parameter is recommended for the class, and a pointer to a limited values table. The privacy indicator could be as simple as a yes/no indicator, or could be stored as a range (e.g. 0-10), or could include some other information such as a passcode. In the latter case the field would need to be enlarged. As configured, each record consumes 32 bytes, providing 16 records per block for data storage structures using logical block lengths of 512 bytes. Even assuming 10,000 parameters, the table will only be 625 blocks long, or 320,000 bytes.

The units table will probably grow to be quite extensive, because there are more than 9,000 generally recognized units of measurement. The limited values table can advantageously contain a number of values group. For example, one grouping of limited values might be a listing of automobile makers, and another grouping might be a listing of ten or twenty basic colors (red, orange, yellow, green, blue, violet, white, black, tan, silver, gold, etc. The numbers in parenthesis are bytes sizes that could be utilized. It is estimated that the system will contain a thousand or more classes, each with between twenty and 60 parameters. The size of each record in this sample table is 123, providing 4 records per 512 byte block. A table containing 2,000 parameters is only about half a megabyte.

The values table 520 includes a literal of the value name, a designation as to whether this value should be kept private to data providers, and data type (floating point, integer, IP pointer, text, etc), and a pointer to a format designation (e.g. nnn.nnn.nnnn, nnnnn.nn, AAAnn, etc). Since number literals and pointers can be stored directly in the values fields of the items table, the values table only needs to store text. Nevertheless, it is contemplated that there could be several thousand records in the values table. The 16 byte size for values literals is a tradeoff among several different factors, but most especially a desire to accommodate most values literals, while discouraging users from using excessively long values. Sixteen bytes is plenty to store almost all values, including. The reader will note that we avoid most two-word values such as “excellent condition” because “excellent” is a value of the parameter “condition”. There is no need to repeat the parameter within the value. Record in this table are estimated to be 24 bytes, providing 21 records per 512 byte block. A table containing 10,000 values is again only about half a megabyte.

The items table 530 contains a pointer to a user ID record, the date the record was added, a date that the record is scheduled to be deleted, a privacy designator, a pointer to class, a pointer to another record, and a series of parameter/value pairs, (which in this case is shown as 15). Such fields should all be self-explanatory, except perhaps the other record pointer, which can be used to associate records to provide more than 15 parameter/value pairs. For example, storing of searches is preferably implemented using two records. The first record could advantageously include the parameters and values identified by the user through a Save History interface such as table 310 (FIG. 4D), and the second record could advantageously include the actual search parameters entered by the user through a Search interface such as table 51 (FIG. 1A). The same could also be true for records sets, where the first record could advantageously include the parameters and values identified by the user through a Save History interface such as table 320 (FIG. 4D), and the second record could advantageously include a listing the records. Still further, the same system could be used for storing user information, where the first record could advantageously include the parameters and values for Last name, First name, Address1, Address2, City, State, Country, and Postal Code, and the personal information 332 of FIG. 6, and the second identified by the user through a Save History interface such as table 320 (FIG. 4D), and the second record could advantageously include a listing the records. The second record, could of course point to a third record, which could point to a fourth record, and so forth.

Assuming the parameter pointers require only three bytes, and that numbers can be stored in five bytes, the record is 126 bytes long, which allows 4 records per 512 byte block. Thus, one could store 500 million item records using only about 12.5 gigabytes of storage. As discussed elsewhere herein, the items can include records characterizing all manner of marketplace goods and services, intellectual goods and services such as newspaper, magazine, and journal articles, times and locations of movies and other entertainment events, information on conferences, as well as any other type of information, and queries and record sets.

Those skilled in the art will appreciate, however, that data structure 500 is extremely inefficient for searching. To match all items for a given class that have five or six parameter/value limitations, the system has to filter by class, then parse and examine the entire record of every record. For instances where there are hundreds of thousands of records, that process is just way too slow. That problem can be readily resolved by using edge caches as set forth in my co-pending application, 60/728370 filed Oct. 18, 2005, where a given column in a table can represent multiple different parameters, including different data types.

Readers should also appreciate that the system is capable of handling multiple instances of a given parameter for a given item. Thus, in characterizing a person in a personals advertisement record, the person (or computer) entering the data could list interests in a particular order of importance, using for example, “interest1”, “interest2”, “interest3”, or perhaps “primary interest”, “secondary interest”, “tertiary interest”, or the person or computer could simply enter the data using multiple instances of a generic “interest” parameter.

In FIGS. 6A-6F, a preferred interface 600 generally includes the company identifier 10 and navigation line 20 discussed previously, and also a flat table having nine columns and a slider. The specific number, designation, and arrangement of the columns is preferential only, and should be interpreted generically to represent all suitable columns, and even arrangements that provide the needed information but are not columnar. In this particular embodiment, it is contemplated that the tables of FIGS. 6A-6F would show records filtered according to selections made in search interfaces such as those shown in FIGS. 1A-1D.

Item/Lot column 610 lists textual descriptions of the subject matter of a proposed transaction, which are not necessarily the same as the item descriptions stored elsewhere on the system for the item. This allows one to describe a “lot” using different or additional language from the name of the item. Double clicking, or in some other way accessing a particular cell in this column would advantageously trigger another window 610A (FIG. 6B) that display details as to the item or lot. It is contemplated that all manner of goods and services can be described in this manner. In the example of FIGS. 6A-6E, the items listed are Samsung i700 personal digital assistants (PDAs). Other items could just as easily have included any other types of goods, including for example cameras, furniture, hearing aids, clothing, jewelry, plants, automobiles, houses, etc, and even stocks or bonds or other financial instruments. Line items for services are also contemplated, including for example repair services, medical, or legal services. Thus, it is contemplated that patients could someday use the systems and methods contemplated herein to consolidate their purchasing power to buy tooth cleaning services, face lifts, vision correction, or even hip replacements. As yet another example, injured consumers could use the systems and methods contemplated herein to consolidate their causes of action in choosing a class action attorney, or perhaps in securing patent drafting services. Thus, the specific example of the Samsung i700 should be interpreted as being emblematic of all suitable goods and services.

Focusing now on FIG. 6B, one would presumably utilize the parameter/value pairs of FIGS. 1-4 in populating window 610A, because users would then receive the benefits of parametized searching and sorting, and the ability to characterize the items/lots in a manner that provides flexibility while encouraging uniformity. But that is not a strict limitation. One could, for example, use a few standard fixed fields such as description, price, and quantity, and leave most of the details to a memo field. Similarly, it is not at all necessary for the parametized item description in window 610A to match the item/lot description in column 610, and indeed it is probably better if those two descriptions can be distinct from one another. Otherwise multiple lots for the same item could get confusing.

It is contemplated that a user could reach the interface of FIG. 6A in any suitable manner. Preferably, however, users would reach the interface by searching for items of interest using a search interface such as that shown in FIGS. 1A-1E. Then, when viewing a summary results listing such as that shown in FIGS. 2A-2B, the user would click on a specific on the Consolidate button in the navigation line 210. Alternatively, from a detailed result for a specific item, such as that shown in FIG. 2C, the user could also click on the Consolidate button in the navigation line 210.

In each row, Maker 615 lists the person or other entity that sets the basic terms of the proposed consolidation. As user herein, “basic terms” are the boundaries of the proposed agreement that is being proposed, can include items such as dates that the proposed consolidation opens and closes for members and bidding, methods of payment, and so forth. The basic terms would preferably be terms common to all parties concerned, and in most contemplated transactions would be necessary to prevent undue complexity in the negotiation. Double clicking on, or otherwise accessing Maker 615 preferably links to a window 615A (FIG. 6C) that shows key details of the Maker. Note that the Maker would probably be, but is not necessarily the same as the person responsible for adding the corresponding item record. In this particular example considerable information is shown about the Maker, but it might also be that the Maker will choose to hide some of the information from view of others. Thus, the parameters and values in window 615A could be populated automatically by the system, or added by the Maker when setting up the proposed consolidation, or perhaps modified by the Maker after having been automatically populated by the system. The “▾” symbols represent drop downs that would presumably be enabled for the Maker to add, delete or modify information, and would be disabled or absent from instances of the window displayed to others.

Action/Terms 620 preferably provides a one word or other very short description of the proposed transaction from the point of view of the Maker. Double clicking on, or otherwise accessing Action/Terms preferably links to a window 620A (FIG. 6D) that shows details of the basic action and terms of the proposed transaction, again preferably from the point of view of the Maker. The specific parameters used could be static, or dynamically added, deleted or modified by the Maker. The “▾” symbols represent drop downs that would presumably be enabled for the Maker to add, delete or modify information, and would be disabled or absent from instances of the window displayed to others. Terms can preferably be saved are accessed using a Template button, such as that shown in the navigation line of window 620A.

In this particular example, the Maker chose to have several restrictions on the proposed transaction, including that payment must be by credit or debit card, shipping costs, and so forth. The only negotiable term is really price, which is shown as ≦$450.00. It is contemplated that the systems and methods used herein could be modified to negotiate on other terms as well, but that is currently considered to be highly disfavored because of the complexity and uncertainty. One can presume that anyone willing to purchase a PDA for $450 would be perfectly happy purchasing the very same PDA for $400 or $350. Similarly, one can presume that anyone willing to sell a lot of PDAs for $450 would be perfectly happy purchasing the very same PDAs for $475 or $500. But the same cannot be said across sellers and buyers for other terms, such as shipping cost and methods, payment terms, and so forth. It is for this reason that the most preferred embodiments allow Makers to set numerous basis terms, leaving open only price. If a subsequent user of the system doesn't like the basic terms proposed by a given Maker, he is able to set up a new proposed transaction as a new Maker, and set the terms to whatever he thinks would be appropriate. But of course the transaction will likely only attract other players to the extent that the basic terms are attractive to those other players. In this manner the strategy should provide a great deal of flexibility, while encouraging conformity.

Designation of Buyer Commit Window and Seller Commit Window values are currently thought to be highly desirable for a workable negotiation. The reason is that a consolidation only works where the quantity is high enough to force a discount or other desirable term on the counterparty (or counterparties). For example, a wholesaler (or even Samsung) may be willing to give a very good price to sell a lot of 300 units, and an even better price to sell a lot of 1000 units. But those sellers presumably have thresholds for their various price points, and are loath to sell a smaller quantity of units at a price reserved for a higher quantity. If potential buyers could commit to buying a unit at the currently negotiated price, but could withdraw that commitment at any time, the deal could easily fall apart at any time. A buyer commit window of several days, for example, gives other parties and potential parties to the transaction a higher confidence level that the deal will actually go through, and is contemplated to facilitate negotiations. Of course, too large a commit window might have the opposite effect, scaring away potential parties. The seller commit window is important from the other end of the transaction, there again providing confidence to parties and potential parties.

In this particular example the Maker has set the buyer commit window to 7 days, and the seller commit window to 999 days, which is effectively through the close date. This are currently thought to be desirable terms for many transactions involving relatively small consumer items, although it is contemplated that either or both terms could be different from that shown in this example.

One issue that will undoubtedly arise is what happens at the end of the commit window. It could be that the entity would be granted the opportunity to withdraw through the close date, but that solution is thought to be relatively undesirable because it would tend to undermine the stability of the negotiations. A better strategy is to allow entities to designate their intention to withdraw from participation in the proposed transaction at any point prior to the end of their particular commit window. If they so designate their intention to withdraw in that time period, then their commitment vanishes at the end of window. But if they do not so designate, then their commitment automatically renews for another commitment window. An example of how this can be implemented is in the table and chart 640A of FIG. 6D.

Date Close 625 is the date and possibly time that the transaction is set to close negotiations. Clicking on the Date Close might bring up another window (not shown) with additional information, such as a calendar or perhaps a time. Only so much information can realistically be shown in a simple table, and the date of close is thought to be of sufficient importance, and ready readability,

Qty Commit 630 and Price Commit 635 are shown in the table because they are critical to the transaction, and are short enough for easy readability. The values for each of those cells would very likely be set by the Maker, and indeed would likely be echoed from the table in Action/Terms window 620A. The names should be self-explanatory.

Qty Commit is the number of items in the lot that are open to consolidation, and are bid against by the counterparty or counterparties. In this particular example, the Maker identified as Smith has set a “buy” commitment of 300 i700s in the table of in Action/Terms window 620A, and that information is echoed in the corresponding row of FIGS. 5A-5E. The system will then allow individual persons or other entities to commit to purchase i700 under the basic terms, up to the limit of 300 units. Once the 300 units commitment is set, the system will likely still take waiting list commitments, but the persons or other entities on the waiting list will only be a part of the consolidation if there is a default or other problem with a person on the primary list. On the other side of the equation, the sellers know that they are only on the hook to sell the i700s if the sale involves 300 units. This allows, and indeed encourages, the sellers to compete against one another for price.

Table 640A of FIG. 6D shows a sample interface that displays individual commitments, and that allows addition of new commitments. In this particular example there is along list of individual commitments, most of which are off the table as demonstrated by the slider on the right hand side of the table. Of the commitments that are shown, one of the commitments is scheduled to be withdrawn on the commitment expiration date of Feb. 13, 2005, and several of commitments are shown as being wait listed (i.e. contingent upon openings being freed up by others). The chart to the right of the table depicts the commitments graphically, with grey blocks representing commitments that can be withdrawn, and black blocks represented commitments that cannot be withdrawn.

Price Commit is the maximum price for transactions where the Maker is the buyer or minimum price for transaction where the Maker is the seller.

Buy Commit 640 is the sum of the commitments made by the entities on the side of the buyers. In this instance the buy commit is 321 because the transaction is oversubscribed. In such oversubscribed situations the winning seller could presumably limit his sales to the quantity commit of the basic terms, or agree to satisfy all of the committed buyers, including the wait listed buyers. Obviously, if the Maker were on the other side of the transaction, the buy commit in the 7^{th} column would be replaced a sell commit, or other accommodations could be made so that the table makes sense.

In this example Sell Commit 645 and Sell Price 655 are the quantity and price that one or more counterparties to the Maker are willing to sell their i700s to individual ones of the consolidated group of buyers. The system will preferably use an algorithm that allows multiple entities to make entries, but will remove or somehow mark as inactive or withdrawn entries that have been superseded. Here, the corresponding detail window 650A shows that a company named Samsung Direct made an initial offer to satisfy the entire buyer commitment of 300 units at the highest acceptable price $450 per unit. The next day, Electronics Outlet made a slightly lower offer at $440, but could/would only commit to selling 188 units. In preferred embodiments, that offer would not supersede the offer from Samsung Direct, because the quantity was insufficient. Later, A&T Imports committed to selling 250 units at $435 per unit, would not, under currently preferred embodiments, supersede the offer from Samsung Direct, because there is no offer of a given price for the entire quantity set forth in the basic terms. However, the chart shows that a few days later Samsung Direct came back and offered to match the $435 price of A&T Imports, and provide the remaining 50 units. That commitment mooted the original commitment from Samsung Direct, and Electronics Outlet, so those rows are interlineated, removed, or otherwise designated as having been mooted. Of course, until the close date/time, others could bid against the combination of A&T Imports and Samsung Direct. In addition, those skilled in the art will appreciate that there are any number of other algorithms that could be used instead of, or in addition to that described with respect to this particular example.

In FIG. 6F a Maker has set forth a hierarchical listing of items to be purchased. In this particular case the Maker is purchasing a garage, that comprises numerous components, including foundation, framing, roof, and so forth. Two of the components, Electrical and Paint, have subcomponents. Those skilled in the art will appreciate that the concept can readily be extended to more than three levels of hierarchy.

The table 610 of FIG. 6F is arranged in substantially the same manner as that of FIGS. 5A-5E. Here, of course, there is different data, but the principles are the similar. The Maker has set forth basic terms, and seeks bidders against the various lots identified in the different rows. Sellers compete against each other using the electronic interface. The Maker in this case might be an individual in a neighborhood that was build without garages, and who is hoping that several others in the local area will want to join with him in having garages built. In this particular example, there are commitments from 12 of the needed 15 buyers, and adequate bids have been placed to provide most of the items, but not siding or wallboard. In some instances, such as framing, bidders have competed with each other to provide a price lower than the maximum commitment price (i.e. $2,200 instead of $2,500).

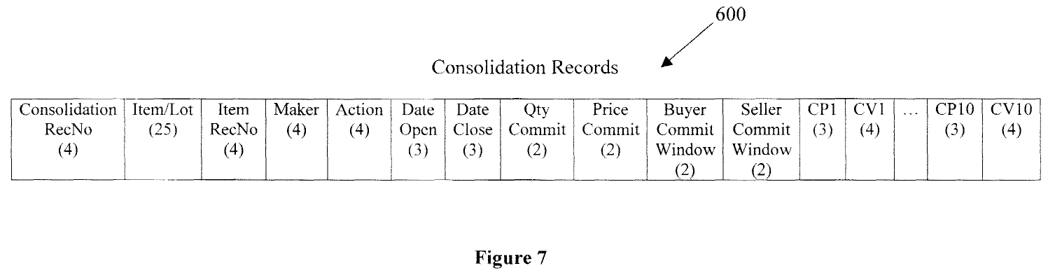

FIG. 7 shows a record format 700 that can advantageously be used to store consolidation information. In this particular example, the record includes an Item/Lot description, which corresponds to column 710 in FIGS. 6A-6F. Format 700 also includes a pointer to the item record that provides information for the table of window 610A, as well as a pointer to a Maker record that provides information for the table of window 615A, fixed fields to store information on Maker, action, date and time of open and close, quantity commit, and price commit, corresponding to the columns 610-645 in FIGS. 6A-6F, and displayed in the table of window 620A. Additional fixed fields store buyer and seller commit windows.

Still further, it is contemplated that users will want to include other terms in their negotiations/agreements, including for example shipping information, payment arrangement for distribution of payment among multiple parties, reserve price, and so forth. Information from the fixed fields, as well as information relating to the other terms is preferably stored as parameter value pairs in additional fields (CP1 (consolidation parameter 1), CV1 (consolidation value 1), etc), and displayed along with the fixed field data in the table of window 620A.

In the above described examples, it was contemplated that the parties would negotiate only on price. In other words, all aspects of a proposed deal were set by the Maker, with only the price left to float. The main reason for that restriction is that with multiple parties on one or both sides of a transaction, it is thought that negotiating other terms would just become unworkable. In addition to triggering spin off side deals, even the display of information would be terribly complex. Nevertheless, it is contemplated that the concepts discussed herein could be adapted to handling transactions where one or both sides has multiple parties, and more than one of the terms is allowed to float, with or without thresholds for the various floating terms.

Thus, specific embodiments and applications of data storage and transaction systems that accommodate consolidated buyers and/or sellers have been disclosed. It should be apparent, however, to those skilled in the art that many more modifications besides those already described are possible without departing from the proposed claims and the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. (class 707/2,10), A system for managing negotiations for a proposed transaction involving a first side and an opposing second side, comprising:
a data structure that stores identification and participation information regarding a plurality of subscribing parties that subscribe to consolidate their resources to satisfy requirements of the first side of the proposed transaction;
a first interface through which a maker from among the subscribing parties can set basic terms of the proposed transaction;
a second interface through which individual ones of the subscribing parties can enter their participation information; and
a third interface through which a first responding party on the opposing second side of the transaction parties can enter its participation information.

2. The system of claim 1, wherein the data structure comprises a plurality of interlinked flat tables.

3. The system of claim 1, wherein the first interface allows the maker to set at least some of the basic terms at least in part by selecting parameters from a previously stored parameters list.

4. The system of claim 3, wherein the first interface allows the maker to add a new parameter to the parameters list, and presents a subsequent maker with the parameter list updated to include the new parameter.

5. The system of claim 1, wherein the first interface allows the maker to set at least some of the basic terms at least in part by selecting values from a values list.

6. The system of claim 5, wherein the first interface allows the maker to add a new values to the values list, and presents a subsequent maker with the values list updated to include the new value.

7. The system of claim 1, wherein the second interface includes a functionality to prevent the subscribing parties from over-subscribing the transaction.

8. The system of claim 1, further comprising a facility to store as the basic terms at least three of: action, item description, quantity, maximum price, commitment window, and close date.

9. The system of claim 1, further comprising a facility to store the basic terms using a parametized item description.

10. The system of claim 1, wherein the third interface allows the responding party to enter its participation in the proposed transaction at less than 100%.

11. The system of claim 1, wherein the third interface allows a second responding party to consolidate its resources with the first responding party to satisfy requirements of the second side of the proposed transaction.

12. The system of claim 1, wherein the third interface allows a second responding party to bid against the first responding party.

13. The system of claim 1, wherein the third interface allows multiple additional responding parties to consolidate their resources to collectively bid against the first responding party.

14. The system of claim 1, wherein the third interface allows multiple additional responding parties to consolidate their resources to collectively bid against the first responding party.

15. A method of facilitating a transaction involving transfer of funds, comprising:
providing a first electronically operable facility through which a maker can set basic terms of the transaction;
providing a second electronically operable facility through which a second unrelated party can join with the maker in consolidating their resources to satisfy one side of the transaction; and
providing a third electronically operable facility through which a third unrelated party can subscribe as a counterparty to the transaction.

16. The method of claim 15 wherein a fourth unrelated party can join with the third party in consolidating their resources to satisfy a second side of the transaction.

17. The method of claim 15 wherein the second electronically operable facility is open to the general public.

18. The method of claim 15 wherein the third electronically operable facility is open to the general public.

19. The method of claim 15 further comprising operating the transaction as a forward auction.

20. The method of claim 15 further comprising operating the transaction as a reverse auction.

21. The method of claim 15 further comprising operating the transaction such that the maker and the second party act as buyers and the third party acts as a seller.

22. The method of claim 15 further comprising operating the transaction to secure a service from the third party.

23. The method of claim 15 further comprising operating the transaction to purchase goods that are not yet in existence.

24. The method of claim 15 further comprising operating the transaction to purchase a combination of goods and services.

25. The method of claim 15 further comprising operating the transaction to purchase multiple lots of goods.

26. The method of claim 15 further comprising completing a legally binding agreement among at least the first, second, and third parties.
